(19) United States
(12) Patent Application Publication
(10) Pub. No.: US 2004/0001990 A1
(43) Pub. Date: Jan. 1, 2004

(54) Fuel battery, and manufacturing method therefor

(75) Inventors: Hisayoshi Ohshima, Oobu-shi (JP); Masahiko Suzuki, Hoi-gun (JP)

Correspondence Address: OLIFF & BERRIDGE, PLC, P.O. BOX 19928, ALEXANDRIA, VA, 22320, US

(73) Assignee: DENSO CORPORATION, Kariya-City (JP)

(21) Appl. No.: 10/455,382

(22) Filed: Jun. 6, 2003

(30) Foreign Application Priority Data
Jun. 26, 2002 (JP) 2002-186031

(51) Int. Cl. H01M 2/08; B05D 5/12; H01M 4/86; H01M 8/10

(52) U.S. Cl. 429/35; 429/30; 429/44; 427/115

(57) ABSTRACT

Provided is a fuel battery excellent in heat resistance and capable of facilitating assembling through the use of a less number of parts and of increasing the degree of freedom of configuration. An oxygen electrode 11 for reducing oxygen and a fuel electrode for oxidizing a fuel are formed in a porous ceramic substrate, with an ionic conduction part being formed between the oxygen electrode and the fuel electrode. In addition, in the ceramic substrate, gas barrier regions are formed to establish the isolation between the oxygen and the fuel. Still additionally, an oxygen supply region is formed in the ceramic substrate to exist on the opposite side to the ionic conduction part with respect to the oxygen electrode and a fuel supply region is formed in the ceramic substrate to exist on the opposite side to the ionic conduction part with respect to the fuel electrode.

### BACKGROUND OF THE INVENTION

1) Field of the Invention

The present invention relates to a fuel battery made to generate electric power through electrochemical reaction between hydrogen and oxygen, and a manufacturing method therefor.

2) Description of the Related Art

As small-size fuel batteries, particularly as small-size fuel batteries which have been studied and developed for portable equipment, there have been proposed many methanol direct type fuel batteries and many pure hydrogen type fuel batteries, each using a solid polyelectrolyte membrane. As disclosed in Japanese Patent Laid-Open Nos. 2001-6700 and 2000-268836, such a fuel battery is made in a manner such that a solid polyelectrolyte membrane, a catalyst layer and others are built up into a sheet-like configuration.

However, each of the fuel batteries thus constructed shows a low heat resistance because a solid polyelectrolyte membrane forming a component is formed as a film-like member, so an operation in a high-temperature zone advantageous to the fuel battery becomes impossible. Moreover, this fuel battery is made up of a large number of parts, which requires complicated assembling. In particular, in a case in which a plurality of fuel cells are built up into a stacked condition, there is a need to pile up the respective parts with high accuracy and then make firm connections therebetween. Moreover, there is a problem in that the degree of freedom of shape is low.

### SUMMARY OF THE INVENTION

The present invention has been developed in consideration of the above-mentioned problems, and it is therefore an object of the invention to provide a fuel battery excellent in heat resistance.

Another object of the invention is to provide a fuel battery capable of reducing the number of parts for simplifying assembling and further of enhancing the degree of freedom of shape.

For these purposes, in accordance with a first aspect of the present invention, there is provided a fuel battery comprising an ionic conduction part (10) formed in a porous ceramic substrate (100) having a large number of pores in a state held in the pores thereof, an oxygen electrode (11) integrally formed in the porous ceramic substrate to be adjacent to the ionic conduction part for reducing oxygen, a fuel electrode (12) integrally formed in the porous ceramic substrate to be adjacent to the ionic conduction part on the opposite side to the oxygen electrode for oxidizing a fuel, and a gas barrier region (15) integrally formed in the porous ceramic substrate to establish an isolation between the oxygen and the fuel.

With this construction, the ionic conduction material provided in the ionic conduction part is held in the ceramic substrate even under high-temperature environments, and the heat resistance temperature of the fuel battery depends upon the quality-change temperature of the ionic conduction material. Accordingly, the heat resistance of the fuel battery is improvable, and the operation in high-temperature areas advantageous to the fuel battery is feasible. Moreover, this decreases the number of parts constituting the fuel battery, thus enabling the manufacturing thereof through simple processes.

According to a second aspect of the present invention, the fuel battery further comprises an oxygen supply region integrally formed in the ceramic substrate to exist on the opposite side to the ionic conduction part with respect to the oxygen electrode, with oxygen being supplied to the oxygen supply region, and a fuel supply region integrally formed in the ceramic substrate to exist on the opposite side to the ionic conduction part with respect to the fuel electrode.

According to a third aspect of the present invention, a plurality of fuel cells each comprising at least the ionic conduction part, the oxygen electrode and the fuel electrode are formed in the ceramic substrate. This extremely improves the degree of freedom of the configuration.

According to a fourth aspect of the present invention, the plurality of fuel cells are disposed to surround the fuel supply region. This can facilitate the isolation of the fuel supply region, and can use an outer circumferential portion of the ceramic substrate as the oxygen supply area.

According to a fifth aspect of the present invention, a plurality of ceramic substrates each corresponding to the ceramic substrate are built up into a stacked condition and put to use. In this case, since the ceramic substrate itself has a porous property, if an adhesive or the like is used in building them up, a high adhesion strength is easily attainable. Moreover, in building up fuel batteries formed in the ceramic substrates, a high accuracy is not required, but they can easily be placed into a stacked condition.

According to a sixth aspect of the present invention, there is provided a method of manufacturing a fuel battery, comprising the steps of preparing a porous ceramic substrate (100) having a large number of pores, holding an ionic conduction part (10) in the pores of the ceramic substrate, forming an oxygen-reduction oxygen electrode (11) integrally on a surface of the ceramic substrate so that the oxygen electrode is adjacent to the ionic conduction part, forming a fuel-oxidization fuel electrode (12) integrally on a surface of the ceramic substrate so that the fuel electrode is adjacent to the ionic conduction part on the opposite side to the oxygen electrode, and forming a gas barrier region on a surface of the ceramic substrate for making an isolation between oxygen and hydrogen. Thus, a fuel battery is producible as a porous ceramic structure.

According to a seventh aspect of the present invention, the method according to claim 6, wherein the ceramic substrate is produced by calcining a molded body produced by extrusion-molding a porous ceramic material.

According to an eighth aspect of the present invention, an organic substance, which disappears when calcined, is mixed into the porous ceramic material so that the pores are formed in the ceramic substrate when the organic substance is calcined to disappear.

According to a ninth aspect of the present invention, in the oxygen electrode forming step and the fuel electrode forming step, the oxygen electrode and the fuel electrode are formed by filling up the pores of the ceramic substrate with a conductive material carrying a catalyst.

According to a tenth aspect of the present invention, the oxygen electrode forming step and the fuel electrode forming step are carried out during the ceramic substrate preparing step, and the organic substance to be mixed into areas of the porous ceramic material where the oxygen electrode and the fuel electrode are formed carries a catalyst on its surface, and is coated with a metallic film so that surfaces of the organic substance appear. Thus, the formation of the oxygen electrode and the hydrogen electrode is achievable in a different manner.

According to an eleventh aspect of the present invention, the ceramic substrate has a hollow part (103), and in the ionic conduction part forming step, the ionic conduction part is formed by filling up the hollow part with an ionic conduction material. This further enlarges the reaction area of the fuel battery, as compared with the case in which the ionic conduction region is formed by filling.

According to a twelfth aspect of the present invention, in the gas barrier region forming step, the gas barrier region is formed by filling up the pores of the ceramic substrate with an insulating material.

According to a thirteenth aspect of the present invention, the gas barrier region forming step is carried out during the ceramic substrate preparing step, the gas barrier region is molded integrally with the ceramic substrate by carrying out co-extrusion of the porous ceramic material and an insulating ceramic material forming the gas barrier. This eliminates the need for forming the gas barrier region independently.

The reference numerals in parentheses attached to the respective means or members signify the corresponding relation with respect to the concrete means in an embodiment which will be described later.

### BRIEF DESCRIPTION OF THE DRAWINGS

Other objects and features of the present invention will become more readily apparent from the following detailed description of the preferred embodiments taken in conjunction with the accompanying drawings in which:

FIG. 1A is a plan view showing a structure of a fuel battery according to a first embodiment of the present invention;

FIG. 1B is a cross-sectional view taken along a line A-A in FIG. 1A;

FIGS. 2A to 2D are illustrations of processes for manufacturing the fuel battery according to the first embodiment;

FIG. 3 is a cross-sectional view showing a filling apparatus for filling up a ceramic substrate with a filler;

FIG. 4 is a cross-sectional view showing a filling apparatus for filling up a ceramic substrate with a filler;

FIGS. 5 and 6 are plan views showing a fuel battery according to a second embodiment of the present invention;

FIG. 7 is a perspective view showing a fuel battery built-up structure according to a third embodiment of the present invention; and

FIGS. 8A to 8D are illustrations of processes for manufacturing a fuel battery according to a fourth embodiment of the present invention.

### DESCRIPTION OF THE PREFERRED EMBODIMENTS

(First Embodiment)

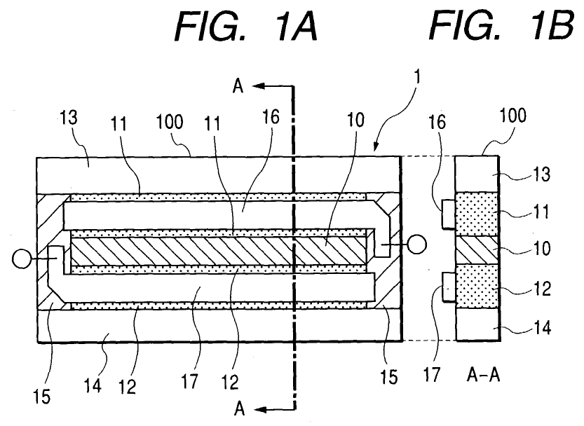

Referring to FIGS. 1 to 4, a description will be given hereinbelow of a fuel battery according to a first embodiment of the present invention. FIG. 1A is a plan view showing a structure of a fuel battery according to a first embodiment of the present invention, and FIG. 1B is a cross-sectional view taken along a line A-A in FIG. 1A. FIGS. 1A and 1B show a single battery cell (fuel battery cell) as a fuel battery 1.

As illustrated in FIGS. 1A and 1B, the fuel battery 1 employs, as a structured body, an insulating porous ceramic substrate 100. In the first embodiment, the porous ceramic substrate 100 has micron-size (approximately 10 μm) voids (or pores). In the ceramic substrate 100, there are formed an ionic conduction region (ionic conduction part) 10, catalyst collection regions 11, 12, an air supply region 13, a hydrogen supply region 14, gas barrier regions 15 and electrode regions 16, 17.

The ionic conduction region 10 is formed in vicinity of a central portion of the ceramic substrate 100 to extend from one surface side of the ceramic substrate 100 to the other surface side thereof. The ionic conduction region 10 is filled up with an ionic conduction material which allows hydrogen ion (proton) and oxygen ion to pass. In the first embodiment, the ionic conduction material is a proton conduction material which allows proton to pass but which does not allow reaction gases (oxygen and hydrogen) to pass. Among employable materials, for example, there are a Nafion gel produced by gelatinizing Nafion (produced by DuPont) and an ionic conductive inorganic hydrated gel (for example, 12-tungstophosphoric acid.

The catalyst collection regions 11 and 12 are formed such that the ionic conduction region 10 is sandwiched therebetween. The catalyst collection regions 11 and 12 constitute an oxygen electrode (positive electrode) 11 for reducing oxygen contained in air and a hydrogen electrode (negative electrode) for oxidizing a fuel (hydrogen). These regions 11 and 12 organize electrodes of the fuel battery 1. The oxygen electrode 11 is disposed to adjoin the ionic conduction region 10, while the fuel electrode 12 is located to be adjacent to the ionic conductor region 10 on the opposite side of the oxygen electrode 11. As well as the ionic conduction region 10, the catalyst collection regions 11 and 12 are formed to extend from one surface side of the ceramic substrate 100 to the other surface side thereof.

In the catalyst collection regions 11, 12, a catalyst carrying carbon material (electric conductive material) carrying a catalyst (for example, platinum) are carried on inner walls of voids or pores of the ceramic substrate 100. For example, a carbon black or an active carbon is employable as the carbon material, while the same proton conduction material as that of the ionic conduction region 10 is employable as the ionic conduction material. In the catalyst collection regions 11 and 12, the voids of the ceramic substrate 100 are not completely closed with the catalyst carrying carbon and the proton conduction material, thereby securing pores through which air and hydrogen serving as a fuel can pass.

The air supply region 13 and the hydrogen supply region 14 are located on both outer sides of the catalyst collection regions 11 and 12. Both the air supply region 13 and the hydrogen supply region 14 are made of void-made ceramics to allow reaction gases to pass.

The air supply region 13 is formed on the oxygen electrode 11 on the opposite side of the ionic conduction region 10. Air containing oxygen is supplied to the air supply region 13 and is then supplied to the oxygen electrode 11. In the first embodiment, air is naturally taken into the air supply region 13 from the atmosphere.

The fuel supply region 14 is formed on the fuel electrode 12 on the opposite side of the ionic conduction region 10. Hydrogen is supplied as a fuel from a hydrogen supply device (not shown) to the fuel supply region 14, and the hydrogen is supplied to the fuel electrode 12. As the employable hydrogen supply devices, for example, there are a high-pressure hydrogen tank, a modification (reforming) device, and others.

The gas barrier regions 15 are formed at both end portions of the ionic conduction region 10 and at both end portions of each of the catalyst collection regions 11 and 12. In order to avoid the direct reaction between oxygen supplied into the air supply region 13 and hydrogen supplied into the fuel supply region 14, the gas barrier regions 15 are constructed to make the isolation between the oxygen and the hydrogen. Moreover, they secure the electrical isolation between the catalyst collection regions 11 and 12. As well as the ionic conduction region 10, the gas barrier regions 15 are also formed to extend from one surface side of the ceramic substrate 100 to the other surface side thereof. The gas barrier regions 15 are filled with an insulating material which does not permit the passage of a gas.

The electrode regions 16 and 17 are constructed as lead electrodes for deriving electric power generated in the fuel battery 1, and are formed on surfaces of the catalyst collection regions 11 and 12, respectively. If these electrode regions 16 and 17 are made to be as large in area as possible, they can reduce a electrical resistance component to carry out effective electric collection.

In the fuel battery 1 thus constructed, when air (oxygen) is supplied to the air supply region 13 and hydrogen is supplied to the fuel supply region 14, the following chemical reaction takes place at the oxygen electrode and the fuel electrode.

(oxygen electrode) 2H⁺+1/2O₂+2e⁻→H₂O

(fuel electrode) H₂→2H⁺+2e −

At the fuel electrode, the hydrogen fuel is separated into hydrogen ions and electrons, and the hydrogen ions pass through the ionic conduction region 10 to move to the oxygen electrode, and at the oxygen electrode, a reaction takes place among oxygen, electrons and hydrogen ions to produce water, thereby generating electric energy.

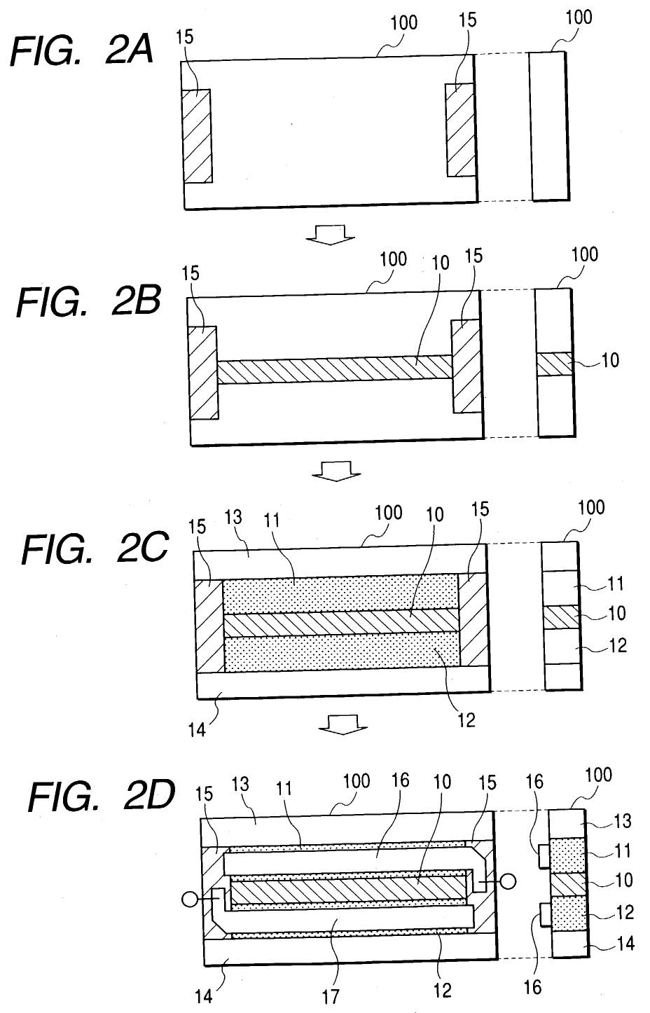

Referring to FIGS. 2A to 2D, 3 and 4, a description will be given hereinbelow of a method of manufacturing the fuel battery 1 constructed as described above. FIGS. 2A to 2D are illustrations of processes of manufacturing the fuel battery 1 according to the first embodiment.

(Process Shown in FIG. 2A)

First of all, a porous ceramic substrate 100 is fabricated. For example, an insulating ceramic powder and a micron-size organic substance are mixed, and sintered after molded and dried. For example, as the insulating ceramic powder, cordierite is employable, and as the micron-size organic substance, styrene beads are employable. Since the styrene beads are calcined and burned out at the sintering, voids appear in the portion where the styrene beads exist, thereby producing the porous ceramic substrate 100 having voids.

Subsequently, the gas barrier regions 15 are formed in areas where air-fuel separation takes place. The gas barrier regions 15 are filled with an insulating substance, such as insulating ceramics including silica or high polymer material (for example, polyimide). As a method of putting an insulating substance in the interior of the ceramic substance 100, a nozzle-drawn method or printing using a screen is available.

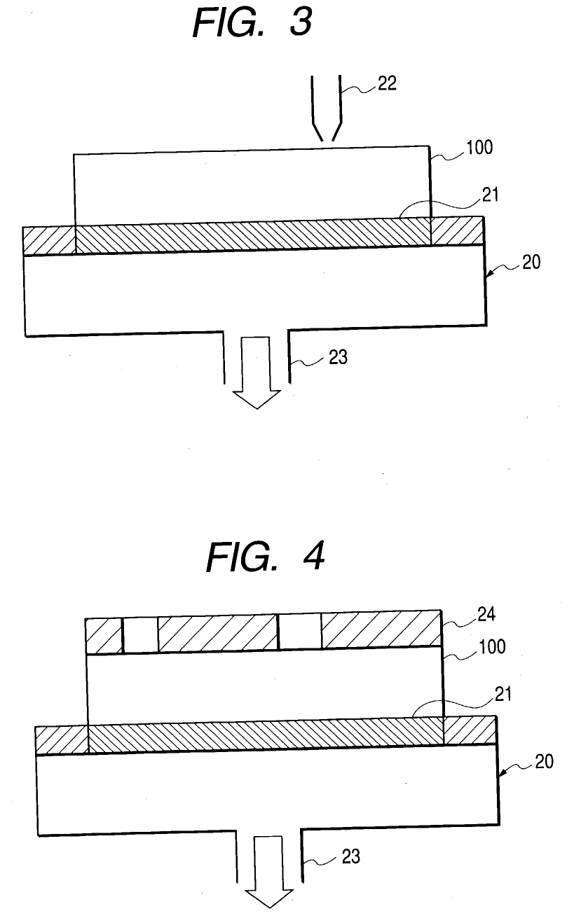

FIGS. 3 and 4 are schematic illustrations of a cross-sectional construction of a filling apparatus 20 for filling up the ceramic substance 100 with a desired substance. FIG. 3 shows an example using a nozzle 22 and FIG. 4 illustrates an example using a screen 24.

As shown in FIGS. 3 and 4, in the filling apparatus 20, a suction opening is made at a position in opposed relation to the nozzle 22 or the screen 24 so that the entire surface of the ceramic substrate 100 can be sucked through a porous bearing body 21 by means of a suction device (not shown; for example, pump) located below the suction opening 23.

In the case of the example shown in FIG. 3, a predetermined pattern is drawn in the ceramic substrate, disposed on the porous bearing body 21 of the filling apparatus 20, with an insulating substance supplied from the nozzle 21. The filler is supplied from the nozzle 21 onto the ceramic substrate 100 in a state where the suction is done through the suction opening 22. Since the suction is done from below, it is possible to prevent the filler from overflowing laterally at the filling to make blots appear at the boundary.

For filling up the ceramic substrate 100 with a filler to draw a desired pattern, the ceramic substrate 100 may be shifted with the nozzle 21 being fixed at a predetermined position. Conversely, the nozzle 21 and the suction opening 22 may be shifted in parallel with the ceramic substrate 100.

In the case of the example shown in FIG. 4, a predetermined pattern is printed with an insulating substance in the ceramic substrate 100, disposed on the porous bearing body 21 of the filling apparatus 20, through the use of the screen printing technique using the screen 24. In the case of the screen printing, since difficulty is encountered in achieving the filling to the lower portion of the ceramic substrate 100 if the printing and the suction are made simultaneously, the processes “printing”→“suction”→“printing”→“suction” are repeatedly carried out to form necessary regions.

(Process Shown in FIG. 2B)

Furthermore, the ionic conduction region 10 is formed after the aforesaid insulating substance is dried. The ionic conduction region 10 is formed such that the ceramic substrate 100 is filled with a proton conduction material to make a connection between the pair of gas barrier regions 15. The proton conduction material for the filling in the ionic conduction region 10 is required to permit the filling in the ceramic substrate 100 and further to have a viscosity whereby it can be held in the voids of the ceramic substrate 100. In the first embodiment, the aforesaid Nafion gel is put to use. The proton conduction material filling method is similar to the aforesaid insulating substance filling method for the gas barrier regions 15.

(Process Shown in FIG. 2C)

Still furthermore, the catalyst collection regions 11 and 12 are formed on both the surfaces of the ionic conduction region 10 so that the ionic conduction region 10 is interposed therebetween. The catalyst collection regions 11 and 12 are filled with a mixture of a carbon material carrying platinum (a carbon black or an active carbon) and a proton conduction material. Since the mixture of the catalyst carrying carbon material and the proton conduction material may be carried on inner walls of the voids of the ceramic substrate 100, before the filling, it is diluted with a solvent, such as alcohol (methanol, ethanol).

Although the filling method is similar to that for the gas barrier regions 15 and others, since the mixture solution shows a high flowability, a protective material, which votatilizes at a low temperature and has a fluidity to be removable, is placed around the catalyst collection regions 11 and 12. As the protective material, a wax material such paraffin is employable. The protective material filling method is also similar to that for the gas barrier regions 15. The protective material is removed from the ceramic substrate by heating after the filling of the mixture.

In forming the catalyst collection regions 11 and 12, a non-filled area (area filled with nothing) is secured at both outsides of the catalyst collection regions 11 and 12, thereby forming the air supply region 13 and the fuel supply region 14.

(Process Shown in FIG. 2D)

Moreover, the electrode regions 16 and 17 are formed on the catalyst collection regions 11 and 12, respectively. The electrode regions 16 and 17 can be formed by patterning according to the screen printing. For the electrode regions 16 and 17, a conductive paste, which has usually been used for the screen printing, is employable.

After the formation of the electrode regions 16 and 17, the solvents left on areas of the ceramic substrate 100 are removed and thermal treatment is made for improving the adhesion. This thermal treatment may be carried out at a temperature below a quality-change temperature which changes the characteristics of the proton conduction material.

The fuel battery 1, shown in FIG. 1, can be completed through the above-described processes. With this construction, the ionic conduction material can be held in the interior of the ceramic substrate 100 even under high-temperature environments. Therefore, the heat resistance temperature of the fuel battery 1 depends upon the quality-change temperature of the ionic conduction material. Accordingly, the heat resistance of the fuel battery 1 is improvable, and the operation in high-temperature areas advantageous to the fuel battery 1 is feasible, which enhances the generation efficiency of the fuel battery 1. In particular, if an inorganic oxide based ionic conduction material is used as the ionic conduction material, the heat resistance thereof becomes further improvable.

In addition, the modification device for producing hydrogen is required to be heated up to a high temperature for the modification reaction. In particular, in a case in which gasoline is used as the modification material, it becomes noticeable. With the construction of the fuel battery 1 according to the first embodiment, since its heat resistance is high, it can be located under high-temperature environments as well as the modification device. This is advantageous when they are mounted in a limited mounting space of a vehicle.

Still additionally, with the construction of the fuel battery 1 according to the first embodiment, the number of parts is reducible, which enables more simplified manufacturing process.

(Second Embodiment)

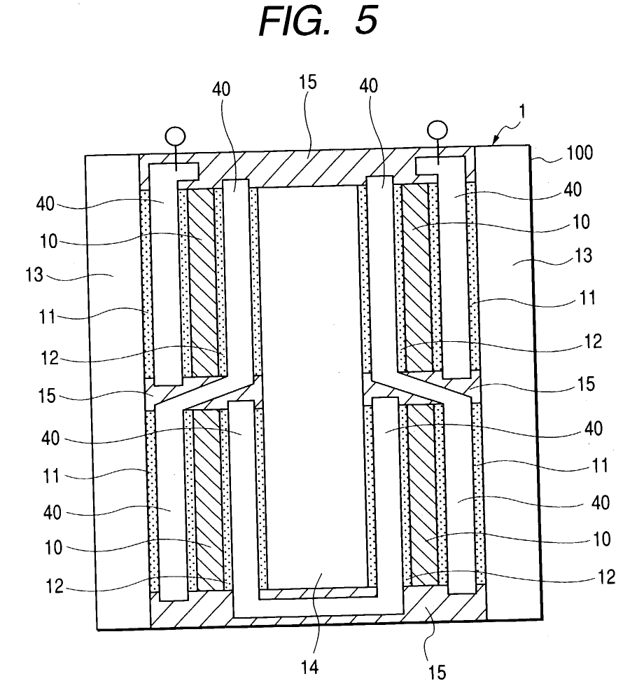

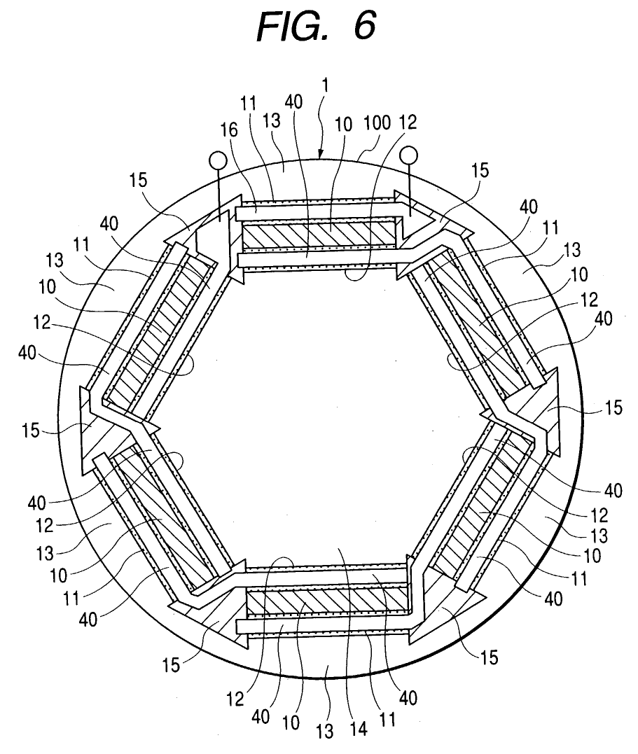

Secondly, referring to FIGS. 5 and 6, a description will be given hereinbelow of a second embodiment of the present invention. The parts corresponding to those in the above-described first embodiment are marked with the same reference numerals, and the description thereof will be omitted for brevity. Therefore, the description of the second embodiment is limited to only the differences therefrom.

FIGS. 5 and 6 are plan views showing a fuel battery 1 according to the second embodiment. In the second embodiment, the fuel battery 1 is constructed by forming a plurality of cells (each constitutes a fuel battery cell) each including an ionic conduction material 10 and a pair of catalyst collection regions 11 and 12 on a ceramic substrate 100. The cells can be connected in series to each other or in parallel with each other. In the case of an example shown in FIG. 5, four cells are connected in series to each other, while in the case of an example of FIG. 6, six cells are connected in series to each other.

Each of the cells can be formed on the ceramic substrate 100 in a manner similar to the processes in the above-described first embodiment. At this time, the respective cells are formed to surround a fuel supply region 14. An air supply region 13 is formed at an outer circumferential portion of the ceramic substrate 100, and gas barrier regions 15 are formed between the respective cells. The adjacent cells are electrically connected to each other through the gas barrier region 15, and common electrode regions 40 formed on oxygen electrode regions 11 of predetermined cells are connected to common electrode regions 40 formed on fuel electrode regions 12 of the adjacent cells.

In the fuel battery 1 thus constructed, air is supplied to the air supply region 13 formed at the outer circumferential portion of the ceramic substrate 100, while hydrogen is supplied to the fuel supply region 14 formed at the central portion of the ceramic substrate 100, thereby making each of the cells generate electricity to attain electric power.

With this construction, a plurality of cells can arbitrarily formed in the ceramic substrate 100, thus extremely increasing the degree of freedom of the configuration. Moreover, since the fuel supply region 14 are surrounded by the respective cells, the isolation of the fuel supply region 14 becomes easily feasible. Still moreover, since the air supply region 13 is placed at the outer circumferential portion of the ceramic substrate 100, the oxygen supply region is effectively formable.

In addition, when the respective cells are disposed in a state where the spacing between the adjacent cells is reduced as shown in FIG. 6, the size reduction of the gas barrier regions 15 becomes feasible.

(Third Embodiment)

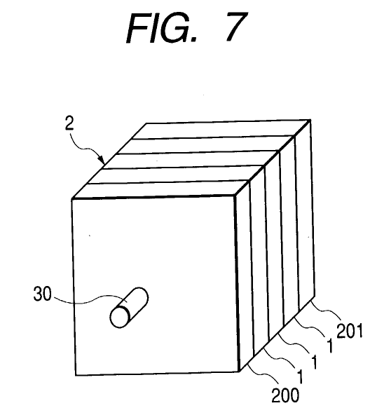

Furthermore, referring to FIG. 7, a description will be given hereinbelow of a third embodiment of the present invention. The parts corresponding to those in the above-described first embodiment are marked with the same reference numerals, and the description thereof will be omitted for brevity. Therefore, the description of the second embodiment is limited to only the differences therefrom.

FIG. 7 is a perspective view showing a fuel battery built-up structure 2 according to the third embodiment. In the third embodiment, the fuel battery built-up structure 2 is constructed by building up a plurality of fuel batteries each corresponding to the above-described fuel battery 1 according to the second embodiment, and the number of fuel batteries 1 to be built up can arbitrarily be set. The respective fuel batteries 1 are connected in series to each other or in parallel with each other.

The respective fuel batteries 1 are fixedly secured to each other through an adhesive. The adhesive is applied to a portion other than at least a fuel supply part 14 of the fuel battery 1. The ceramic substrate 100 itself has a porous structure and, hence, a large adhesion strength is easily obtainable. The adhesive for the adhesion among the respective fuel batteries 1 also functions as a gas seal which is for preventing oxygen supplied to the air supply region 13 and hydrogen supplied to the fuel supply region 14 from come directly into contact with each other. Moreover, since a high accuracy is not required in building up the fuel batteries 1 formed in the ceramic substrates 100 in this way, they can easily be built up into a stacked condition.

In both end portions (uppermost surface and lowermost surface) of the fuel battery built-up structure 2, for example, ceramic substrates 200 and 201 having no gas passage property are built up for the gas seal of the fuel supply part 14. A fuel supply port 30 is made in the uppermost surface ceramic substrate 200, while a fuel purge port is provided in the lowermost surface ceramic substrate 201, when needed.

(Fourth Embodiment)

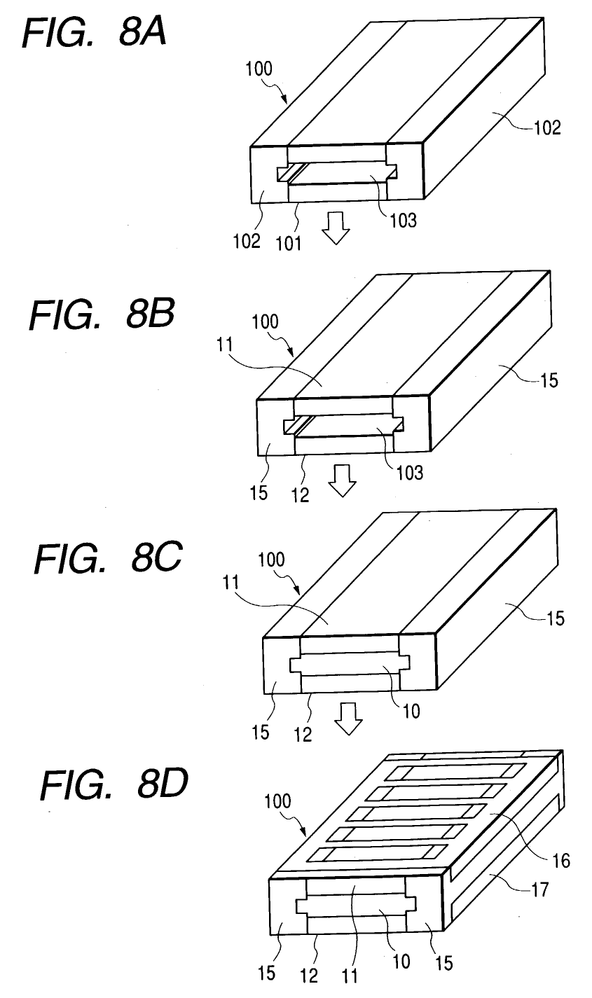

In addition, referring to FIGS. 8A to 8D, a description will be given hereinbelow of a fourth embodiment of the present invention. The parts corresponding to those in the above-described embodiments are marked with the same reference numerals, and the description thereof will be omitted for brevity. Therefore, the description of the second embodiment is limited to only the differences therefrom.

In the above-described method of manufacturing the fuel battery 1 according to the first embodiment, the ionic conduction region 10 and the catalyst collection regions 11 and 12 are formed in the ceramic substrate 100 by means of the filling. However, since the filling encounters the difficulty of making the ionic conduction material and others invade deeply into the interior of the ceramic porous body, difficulty is experienced in enlarging the reaction area of the fuel battery 1. For this reason, the fourth embodiment provides a manufacturing method capable of enlarging the reaction area of the fuel battery 1.

With reference to FIGS. 8A to 8D showing a manufacturing process, a description will be given hereinbelow of a method of manufacturing a fuel battery 1 according to the fourth embodiment.

(Process Shown in FIG. 8A)

First of all, a ceramic substrate 100 is fabricated. In the fourth embodiment, a hollow extrusion molded body having a necessary length is formed by carrying out the co-extrusion (simultaneous or common extrusion) using two types of ceramic materials. As the ceramic materials, a porous ceramic material and an insulating ceramic material are put to use. The porous ceramic material is produced by mixing an organic substance, removable by burning, into a ceramic material. Every insulating ceramic material is acceptable if it has a gas seal property after sintered, and an insulating ceramic material to be used is selected taking into consideration the compatibility with the porous ceramic material, the coefficient of thermal expansion, the viscosity, the rate of shrinkage when sintered, and others.

The insulating ceramic material is positioned at both end portions of the porous ceramic material, and the extrusion molding is carried out so as to establish a hollow part. The extrusion molded body is dried and sintered to produce a ceramic substrate 100 having porous ceramic parts 101, insulating ceramic parts 102 and a hollow part 103. The insulating ceramic parts 102 organize gas barrier regions 15.

(Process Shown in FIG. 8B)

Secondly, catalyst collection regions 11 and 12 are formed on the porous ceramic parts 101. The catalyst collection regions 11 and 12 can be produced by immersing the ceramic substrate 10 in a carbon black solution coped with platinum. Alternatively, the catalyst collection regions 11 and 12 can also be produced by plating inner walls of voids of the porous ceramic parts 101 with platinum forming a catalyst metal by means of the electroless plating. In the case of the plating, in order to prevent it from sticking to the insulating ceramic parts 102, for example, protective films are formed on the insulating ceramic parts 102 or a hydrophobic insulating ceramics is put to use.

Moreover, it is also possible that a catalyst is previously carried on surfaces of an organic substance previously mixed into the porous ceramic material and a metallic film (for example, nickel) is formed (coating) thereon by means of the plating so that the organic substance surfaces appear for the formation of the catalyst collection regions 11 and 12 at the time of the completion of the drying and sintering.

(Process Shown in FIG. 8C)

Following this, the hollow part 103 is filled with a proton conduction material to form a proton conduction region 10. The proton conduction material may be extrusion-injected into the hollow part 103, and it is also possible that the proton conduction material is sucked from the opposite side at the injection.

(Process Shown in FIG. 8D)

Thereafter, electrode regions 16 and 17 are formed on the catalyst collection regions 11 and 12, respectively. The formation of the electrode regions 16 and 17 can be done by means of, for example, the screen printing or mask deposition. The electrode regions 16 and 17 are required to be made as large in area as possible in order to reduce the contact resistance and are required to secure the gas supply regions with respect to the catalyst collection regions. Therefore, in the fourth embodiment, each of the electrode regions 16 and 17 is formed into a comb-like configuration.

The fuel battery 1 according to the fourth embodiment can be completed through the above-mentioned processes. Thus, for enlarging the reaction area, the ionic conduction area 10 is made thin in an ion conduction direction and made long in a direction perpendicular to the ion conduction direction. This can increase the output density of the fuel battery 1.

(Other Embodiment)

In the above-described embodiments, although the ionic conduction region 10 is constructed as a proton conduction region where hydrogen ions travel, the present invention is not limited to this, but it is also acceptable that the ionic conduction region 10 is constructed as an oxygen ionic conduction region where oxygen ions travel.

In addition, in the above-described fourth embodiment, although two types of ceramic materials are co-extruded to mold the ceramic substrate 100, the present invention is not limited to this, but it is also possible to mode the ceramic substrate 100 through the use of only a porous ceramic material. In this case, as well as the above-described first embodiment, areas in which the gas barrier regions 15 are formed may be filled with an insulating material such as an insulating ceramic or polyimide. Thereafter, the fuel battery 1 is fabricated through a process similar to that of the fourth embodiment.

Still additionally, in the fourth embodiment, if the same ceramic material is employed as the porous ceramic material and the insulating ceramic material, the condition on the co-extrustion can easily be set. In this case, as the organic substance to be mixed into the porous ceramic material, there is used a substance which carries no catalyst nor metal. After the molding of the ceramic substrate 100 by the co-extrusion, the filling is made with an insulating material, thus forming the gas barrier regions 15. Subsequently, the fuel battery 1 is fabricated in a manner similar to that of the above-described fourth embodiment.

Yet additionally, in the above-described embodiments, although the ionic conduction region 10, the catalyst collection regions 11, 12, the gas barrier regions 15 and others are formed in the same porous ceramic substrate 100, if, of the components of the fuel battery 1, at least the ionic conduction region 10 is formed in the porous ceramic substrate 100, it is possible to provide a fuel battery having a high heat resistance. In this case, the other components may be constructed through the use of separate members.

It should be understood that the present invention is not limited to the above-described embodiments, and that it is intended to cover all changes and modifications of the embodiments of the invention herein which do not constitute departures from the spirit and scope of the invention.

What is claimed is:

1. A fuel battery comprising:
an ionic conduction part formed in a porous ceramic substrate having a large number of pores in a state held in said pores thereof;
an oxygen electrode integrally formed in said porous ceramic substrate to be adjacent to said ionic conduction part for reducing oxygen;
a fuel electrode integrally formed in said porous ceramic substrate to be adjacent to said ionic conduction part on the opposite side to said oxygen electrode for oxidizing a fuel; and
a gas barrier region integrally formed in said porous ceramic substrate to establish an isolation between said oxygen and said fuel.

2. The fuel battery according to claim 1, further comprising an oxygen supply region integrally formed in said ceramic substrate to exist on the opposite side to said ionic conduction part with respect to said oxygen electrode, with oxygen being supplied to said oxygen supply region, and a fuel supply region integrally formed in said ceramic substrate to exist on the opposite side to said ionic conduction part with respect to said fuel electrode.

3. The fuel battery according to claim 1, wherein a plurality of fuel cells each comprising at least said ionic conduction part, said oxygen electrode and said fuel electrode are formed in said ceramic substrate.

4. The fuel battery according to claim 3, wherein said plurality of fuel cells are disposed to surround said fuel supply region.

5. The fuel battery according to claim 1, wherein a plurality of ceramic substrates each corresponding to said ceramic substrate are built up into a stacked condition and put to use.

6. A method of manufacturing a fuel battery, comprising the steps of:
preparing a porous ceramic substrate having a large number of pores;
holding an ionic conduction part in said pores of said ceramic substrate;
forming an oxygen-reduction oxygen electrode integrally on a surface of said ceramic substrate so that said oxygen electrode is adjacent to said ionic conduction part;
forming a fuel-oxidization fuel electrode integrally on a surface of said ceramic substrate so that said fuel electrode is adjacent to said ionic conduction part on the opposite side to said oxygen electrode; and
forming a gas barrier region on a surface of said ceramic substrate for making an isolation between oxygen and hydrogen.

7. The method according to claim 6, wherein said ceramic substrate is produced by calcining a molded body produced by extrusion-molding a porous ceramic material.

8. The method according to claim 7, wherein an organic substance, which disappears when calcined, is mixed into said porous ceramic material so that said pores are formed in said ceramic substrate when said organic substance is calcined to disappear.

9. The method according to claim 6, wherein, in said oxygen electrode forming step and said fuel electrode forming step, said oxygen electrode and said fuel electrode are formed by filling up said pores of said ceramic substrate with a conductive material carrying a catalyst.

10. The method according to claim 9, wherein said oxygen electrode forming step and said fuel electrode forming step are carried out during said ceramic substrate preparing step, and said organic substance to be mixed into areas of said porous ceramic material where said oxygen electrode and said fuel electrode are formed carries a catalyst on its surface, and is coated with a metallic film so that surfaces of the organic substance appear.

11. The method according to claim 6, wherein said ceramic substrate has a hollow part, and in said ionic conduction part forming step, said ionic conduction part is formed by filling up said hollow part with an ionic conduction material.

12. The method according to claim 6, wherein, in said gas barrier region forming step, said gas barrier region is formed by filling up said pores of said ceramic substrate with an insulating material.

13. The method according to claim 12, wherein said gas barrier region forming step is carried out during said ceramic substrate preparing step, said gas barrier region is molded integrally with said ceramic substrate by carrying out co-extrusion of said porous ceramic material and an insulating ceramic material forming said gas barrier.
